(19) United States
(12) Patent Application Publication
(10) Pub. No.: US 2002/0129500 A1
(43) Pub. Date: Sep. 19, 2002

(54) Table fork

(76) Inventor: Ting-Shan Chiu, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/804,259

(22) Filed: Mar. 13, 2001

(51) Int. Cl. A47J 43/28

(52) U.S. Cl. 30/322

(57) ABSTRACT

A table fork includes a fork handle and a fork body. The fork body has a base plate having a plurality of protruding main and assistant tines arranged around on an upper surface, possible to fork and hold several pieces of food at one time, letting an eater feel satisfied with eating with a mouthful without soiling a hand, and also able to keep forked food steady on the tines, preventing forked food from dropping down or dangling around.

### BACKGROUND OF THE INVENTION

This invention relates to a table fork, particularly to one possible to fork at one time several pieces of food such as popcorns or the like and keep them steady on tines, not to drop down or dangle around, and not to soil an eater's hand or food itself.

Progress in social culture has by degrees elevated man's living quality, and table etiquette is appreciated everywhere in man's life nowadays. For instance, various table knives and forks instead of hand are commonly used for meals, except some special foods.

However, a conventional known table fork generally formed to have several tines arranged in a line or a straight single tine has the following defects in use.

1. A table fork with such a structure can hardly fork at one time lots of popcorns or the like, impossible to satisfy a man's craving for eating with a mouthful.

2. A table fork with its tines arranged in a line or with a straight single tine can not easily fork soft food and hold it up, liable to render soft food broken to pieces, resulting in an embarrassment.

3. Soft food may be forked and carried up, but most likely, will be broken to pieces, if a table fork having its tines arranged in a line or a single tine.

4. If a single tine of a fork is formed straight, it has to fork food at its center of gravity; otherwise the food being forked will easily dangle around, impossible for an eater to eat an exact part he wants.

Further, as shown in FIG. 5, pincers 3 for holding food have been designed and used; nevertheless it is liable to let clamped food drop and scatter on the ground in process of holding the food ready for eating, if the pincers suddenly loosen open.

### SUMMARY OF THE INVENTION

One objective of the invention is to offer a table fork including a fork handle and a fork body. The fork body is combined with the fork handle, having a plurality of protruding main and auxiliary tines formed annularly on an upper surface, so that it can at one time fork several pieces of food such as popcorns or the like to let an eater feel satisfied with eating with a mouthful.

Another objective of the invention is to offer a table fork with its main and auxiliary tines formed protruding around on the upper surface so that various foods can be forked and held steady, preventing forked foods from dropping and dangling around the tines.

### BRIEF DESCRIPTION OF THE DRAWINGS

This invention will be better understood by referring to the accompanying drawings, wherein:

FIG. 1 is an exploded perspective view of a first embodiment of a table fork of the present invention.

FIG. 2 is an exploded perspective view of a second embodiment of the table fork of the present invention.

FIG. 3 is a perspective view of the table fork in process of forking popcorns of the present invention.

FIG. 4 is a perspective view of the table fork having already forked the popcorns of the present invention.

FIG. 5 is a perspective view of a conventional known pincers in process of holding popcorns.

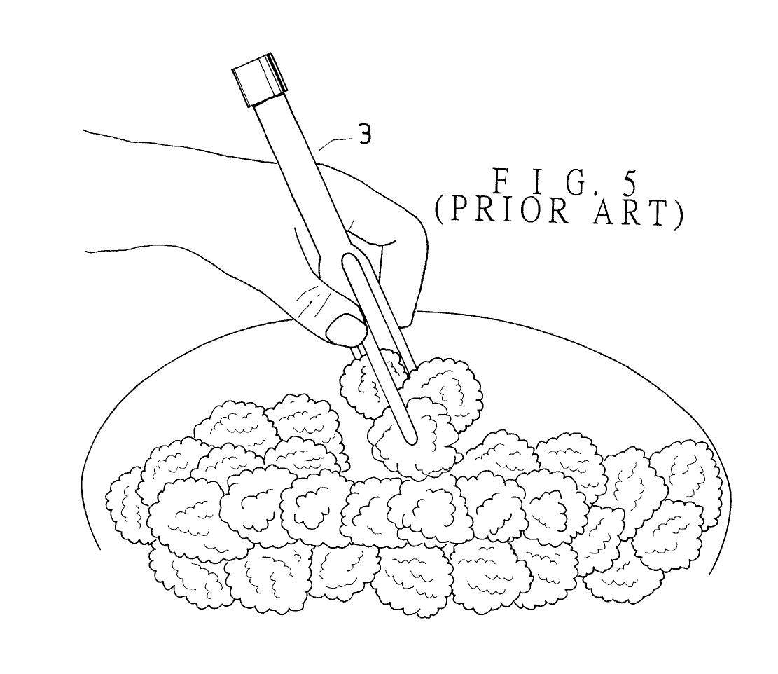

FIG. 6 is a perspective view of the conventional known pincers in process of holding popcorns being eaten.

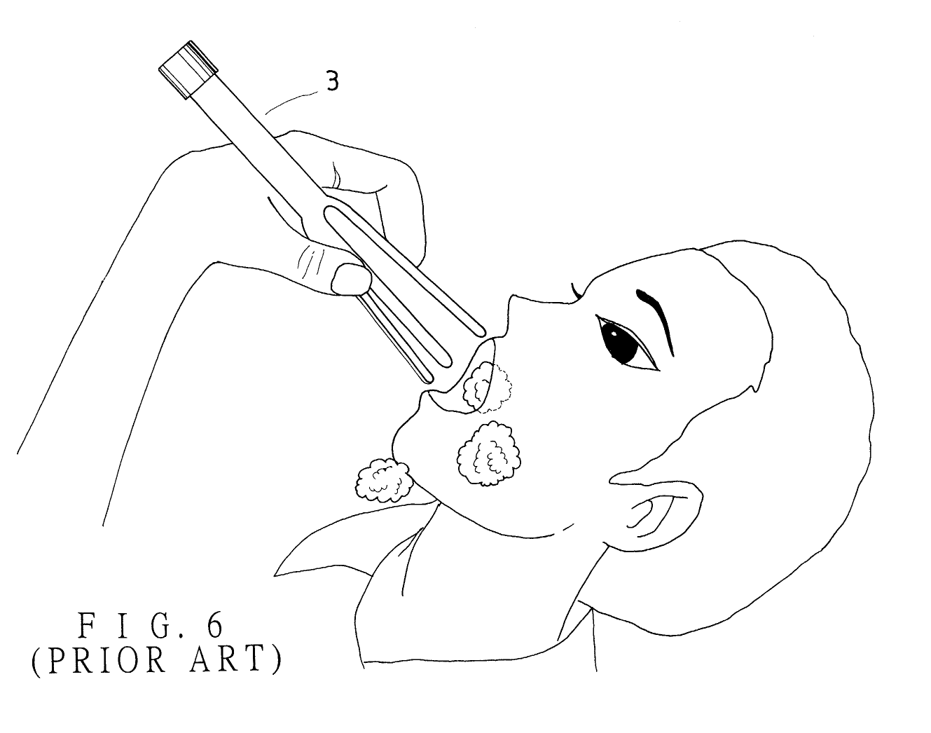

### DETAILED DESCRIPTION OF THE PREFERRED EMBODIMENTS

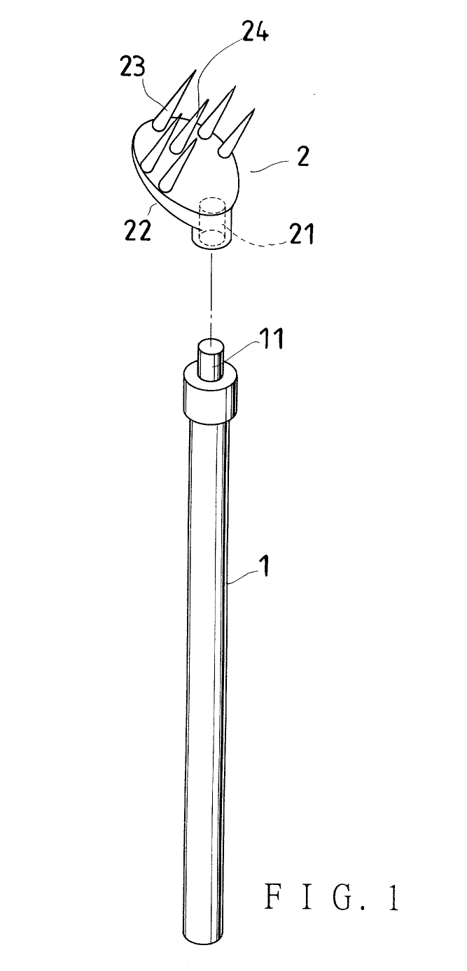

A preferred embodiment of a table fork, as shown in FIG. 1, includes a fork handle 1 and a fork body 2 as main components combined together.

The fork handle 1 has a column-like insert projection 11 on an upper side for receiving the fork body 2.

The fork body 2 has an insert hole 21 under one side of a base plate 22 for receiving the insert projection 11 of the fork handle 1 stably therein. Then the base plate 22 has plural protruding main tines 23 formed spaced apart around near an outer edge, some auxiliary tines 24 formed on a center portion inside the main tines 23.

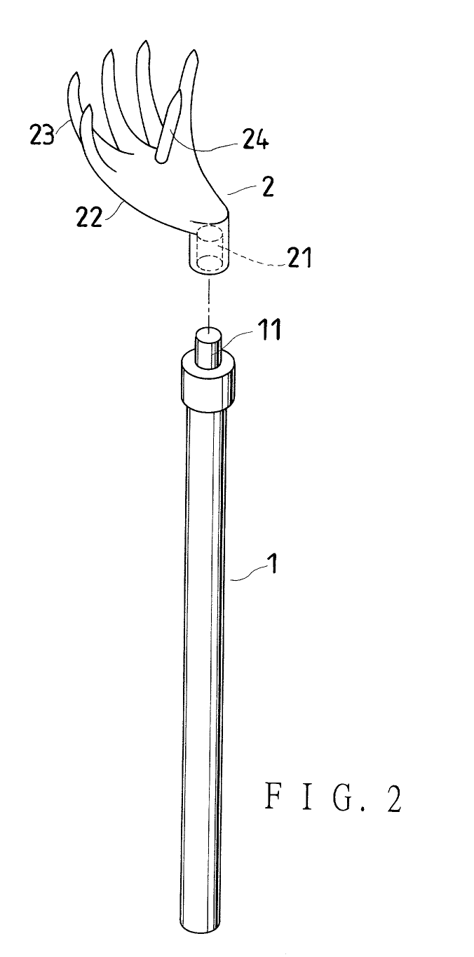

In addition, referring to FIG. 2, fork bodies 2 of different sizes can be made to conform to various sizes of food to be forked.

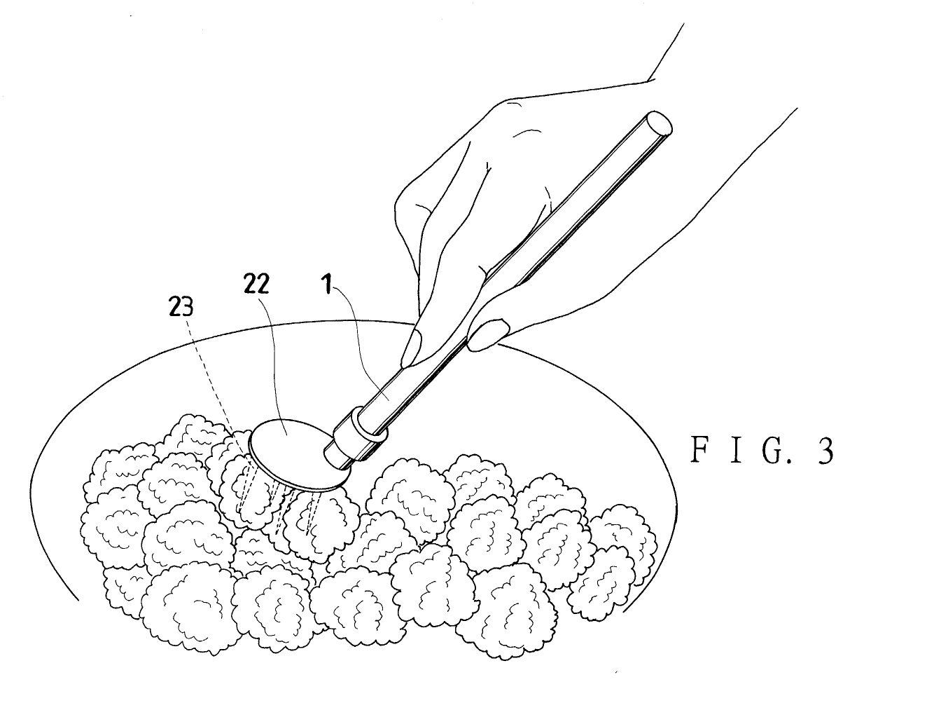

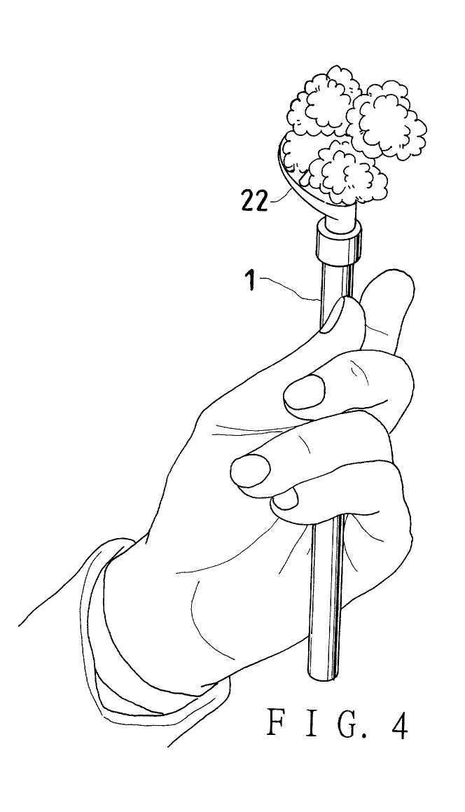

In using, as shown in FIG. 3, the insert hole 21 of the fork body 2 is stably fitted with the insert projection 11 of the fork handle 1. Thus, the main and auxiliary tines 23 and 24 can at one time fork and carry up several pieces of food for eating, as shown in FIG. 4.

As can be noted from above description, the table fork of this invention, compared with conventional known ones, has the following advantages:

1. A plurality of protruding main tines formed annularly on the base plate can at one time fork several pieces of food such as popcorns or the like, letting an eater feel satisfied with eating with a mouthful.

2. Even soft food can be forked and held steady on the main and the auxiliary tines for eating.

3. Soft food, when forked, will not break into bits by means of the main tines arranged annularly on the fork base.

4. With the annularly protruding main tines, food forked in any position will not dangle around the tines so that an eater can easily enjoy an exact part he wants.

5. When forking such food as popcorns or the like, the auxiliary tines formed on the center portion of the base plate prevent forked food from stuck to the lower ends of the main tines, avoiding an embarrassing condition that forked food may not be reached by an eater's mouth.

6. The base plate having the protruding main tines is formed with a proper angle to the fork handle so that food on the tines may be easy to eat.

7. Popcorns packed in a paper bag can easily be forked and carried out of the bag for eating by means of annularly arranged tines, permitting an eater's hand or wrist not stained by touching greasy popcorns.

8. The plural main and auxiliary tines on the base plate can at one time fork lots of popcorns or the like and do not let the forked popcorns or the like drop down even if an eater enjoys eating the forked food one by one.

What is claimed is:

1. A table fork, comprising
a fork handle for holding manually;
a fork body provided on said fork handle, having plural protruding tines on an upper side, and characterized by said fork body having a base plate; said base plate having a plurality of main tines formed protruding around near an outer circumferential edge, said table fork possible to fork and hold at one time several pieces of food such as popcorns and keep them steady on said tines.

2. The table fork as claimed in claim 1, wherein plural auxiliary tines are formed in a center portion inside said main tines to prevent forked food from stuck too deeply to lower ends of said tines, avoiding an embarrassing condition that said forked food may not be reached by an eater's mouth.

3. The table fork as claimed in claim 1, wherein a column-like insert projection is formed integral on an upper end of said fork handle to be stably fitted with an insert hole formed in said fork body, and said fork body of different sizes can be made depending on various sizes of food to be forked.

4. The table fork as claimed in claim 1, wherein said base plate of said fork body forms a proper angle to said fork handle so that forked food may be easy and convenient to eat.
